(19) United States
(12) Patent Application Publication
(10) Pub. No.: US 2008/0163709 A1
(43) Pub. Date: Jul. 10, 2008

(54) Power transmission apparatus and rotation apparatus

(75) Inventors: Dong-Won Choi, Suwon-si (KR); Chil-Sung Lee, Suwon-si (KR); Jae-Kyung Kim, Ansan-si (KR); Jae-Hun Kim, Suwon-si (KR); Kyoung-Shin Park, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/007,045

(22) Filed: Jan. 4, 2008

(30) Foreign Application Priority Data
Jan. 8, 2007 (KR) 10-2007-0001974

(51) Int. Cl. F16H 1/16; E05F 15/10

(52) U.S. Cl. 74/89.14; 49/340

(57) ABSTRACT

A power transmission apparatus and a rotation apparatus are disclosed. A power transmission apparatus that includes: a power generating part, which includes a drive axis; a worm, which is joined to the drive axis; a worm gear, which meshes with the worm, and which includes an output axis configured to transmit power; and a friction hinge, which is joined to the output axis, and which is configured to engage and disengage a rotational force of the output axis, can provide sufficiently high deceleration and high torque, even when a low-capacity motor having a low cogging torque is used. Also, the power transmission apparatus can be made safer and less noisy for not only automatic operation by the motor but also manual operation by a user, while the gear module, motor, etch, can be protected from excessive loads.

### CROSS-REFERENCE TO RELATED APPLICATIONS

This application claims the benefit of Korean Patent Application No. 10-2007-0001974 filed with the Korean Intellectual Property Office on Jan. 8, 2007, the disclosure of which is incorporated herein by reference in its entirety.

### BACKGROUND

1. Technical Field

The present invention relates to a power transmission apparatus and a rotation apparatus.

2. Description of the Related Art

A gear module joined to a motor may serve to reduce the rotational speed transferred from the motor by a particular rate. Multiple gears can be arranged in a gear module, with the rotation of the motor decelerated by the combination of these gears.

Rotating a mass such as a television or computer monitor, however, requires high torque, although a high rotational speed may not be necessary. Thus, as the high rotational speed of the motor has to be reduced to several to several tens of revolutions per minute, a sufficient degree of deceleration may not be achieved with only a gear module, and it may be difficult to obtain high levels of torque.

Furthermore, if the television or computer monitor is rotated, not by the electrical driving of the motor, but by an external force from the user, an excessive load may be imposed on the motor connected to the rotational axis, causing damage to the motor.

### SUMMARY

An aspect of the invention is to provide a power transmission apparatus and a rotation apparatus, which can provide high deceleration and high torque, even when a low-capacity motor having a low cogging torque is used.

Another aspect of the invention is to provide a power transmission apparatus and a rotation apparatus, which are safe against rotating by the user, as well as for automatic rotation by the driving of the motor, and which provide less noise.

One aspect of the invention provides a power transmission apparatus that includes: a power generating part, which includes a drive axis; a worm, which is joined to the drive axis; a worm gear, which meshes with the worm, and which includes an output axis configured to transmit power; and a friction hinge, which is joined to the output axis, and which is configured to engage and disengage a rotational force of the output axis.

The power generating part may include a motor, and a gear module that reduces a rotational speed of the motor by a predetermined rate.

The friction hinge may include an active axis that is joined with the output axis of the worm gear, and a passive axis that is in plane contact with the active axis, where a friction between the active axis and the passive axis may be controllable.

A maximum halting frictional torque between the active axis and the passive axis can be higher than an operation requirement torque of the output axis of the worm gear. Also, the maximum halting frictional torque between the active axis and the passive axis can be lower than a holding torque of the output axis of the worm gear.

Another aspect of the invention provides a rotation apparatus that includes: a fixed body; a link member, of which one end is hinge-joined to the fixed body about a first hinge axis; a connector, which is hinge-joined to the other end of the link member about a second hinge axis; a movable body, which is hinge-joined with the connector about a third hinge axis; and a power transmission apparatus, which is joined to the first, second, and third hinge axes respectively to control a rotation of the first, second, and third hinge axes. Here, the power transmission apparatus includes: a power generating part, which includes a drive axis; a worm, which is joined to the drive axis; a worm gear, which meshes with the worm, and which includes an output axis configured to transmit power; and a friction hinge, which is joined to the output axis, and which is configured to engage and disengage a rotational force of the output axis.

The power generating part may include a motor, and a gear module that reduces a rotational speed of the motor by a predetermined rate.

The friction hinge may include an active axis that is joined with the output axis of the worm gear, and a passive axis that is in plane contact with the active axis, where a friction between the active axis and the passive axis may be controllable.

A maximum halting frictional torque between the active axis and the passive axis can be higher than an operation requirement torque of the output axis of the worm gear. Also, the maximum halting frictional torque between the active axis and the passive axis can be lower than a holding torque of the output axis of the worm gear.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of a power transmission apparatus according to an embodiment of the invention.

FIG. 2 is a schematic drawing illustrating a worm and a worm gear meshed together.

FIG. 3 is a cross-sectional view of a friction hinge according to an embodiment of the invention.

FIG. 4 is a perspective view of a rotation apparatus according to an embodiment of the invention.

FIG. 5 is a schematic drawing illustrating the composition of a rotation apparatus according to an embodiment of the invention.

### DETAILED DESCRIPTION

The power transmission apparatus and rotation apparatus according to certain embodiments of the invention will be described below in more detail with reference to the accompanying drawings, in which those components are rendered the same reference numeral that are the same or are in correspondence, regardless of the figure number, and redundant explanations are omitted.

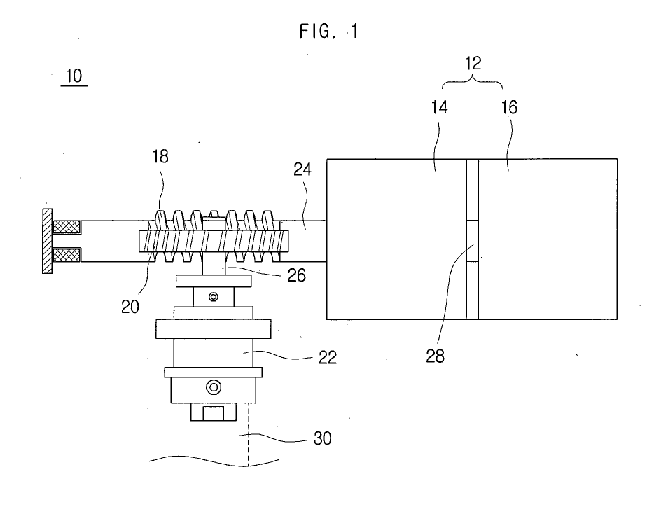

FIG. 1 is a cross-sectional view of a power transmission apparatus according to an embodiment of the invention. In FIG. 1 are illustrated a power transmission apparatus 10, a power generating part 12, a motor 16, a gear module 14, a worm 18, a worm gear 20, a friction hinge 22, a main axis 24, an output axis 26, a drive axis 28, and a rotational axis 30.

The power generating part 12 may be such that provides a rotational force to the drive axis 28, and may employ various apparatus known to those skilled in the art. For example, the rotational force may be provided using a belt and pulleys, or may be provided directly by a motor 16. This particular embodiment will illustrate the case where a motor 16 is used to provide the rotational force. The power generating part 12 may include a drive axis 28. The drive axis 28 may be joined to the rotor of the motor 16, so that the rotation of the rotor causes the drive axis 28 to rotate.

A worm 18 can be joined to the drive axis 28 which transfers the rotational force to a worm gear 20 in meshing arrangement with the worm 18. The worm 18 may be a separate device that is joined with the drive axis 28, or the worm 18 may be formed along the perimeter of the drive axis 28 and integrated as a single body with the drive axis 28. In this embodiment, a gear module 14 may be interposed between the worm 18 and the motor 16, to decelerate the rotational speed of the motor 16 by a particular rate. The gear module 14 may be such that is joined to the motor 16 to decelerate by a predetermined rate the rotational speed transferred from the motor 16. Multiple gears may be arranged in the gear module 14, the combination of which may act together to reduce the rotational speed of the motor 16.

A common motor 16 produces a high rotational speed, such as of about 3000 rpm. In contrast, the rotational speed required in an apparatus for automatically rotating a display, such as an LCD (liquid crystal display) or a PDP (plasma display panel), is between several to several tens of revolutions per minute. As such, a high rotational speed may not be necessary, but instead a high torque may generally be required.

In interposing the gear module 14, a drive pinion (not shown) may be equipped at the end of the drive axis 28 of the motor 16. The combination of multiple gears within the gear module 14 may receive the rotational force transferred by the drive pinion and reduce the rotational speed of the motor by a predetermined rate, with the resulting force transferred through the main axis 24 of the gear module 14. In this case, the worm 18 may be joined to the main axis 24 of the gear module 14, to transfer the rotational force to the worm gear 20 meshed with the worm 18, as described above. The worm 18 may be a separate device that is joined with the main axis 24, or the worm 18 may be formed along the perimeter of the main axis 24 and integrated as a single body with the main axis 24.

While it is possible to decelerate the rotational speed of the motor 16 by a predetermined rate using the gear module 14, the rotation in an apparatus for rotating a display requires a high torque, as well as a low speed. Using numerous gears within the gear module 14 to obtain such high deceleration rate and high torque can create a risk of large backlash within the gear module 14. Thus, in this embodiment, the worm 18 and the worm gear 20 are used, so that after the gear module 14 primarily decelerates the rotational speed of the motor 16, the worm 18 and the worm gear 20 may secondarily decelerate the rotational speed primarily decelerated by the gear module 14, thereby providing not only a high deceleration rate but also a high torque. The arrangement of the worm 18 and worm gear 20 can also reduce backlash in the gear module 14. Furthermore, the worm 18 and worm gear 20 can alter the direction in which the rotational force of the motor 16 may be provided, whereby the power generating part 12 can be positioned with greater freedom without obstructing the rotating position of the rotating apparatus of the display.

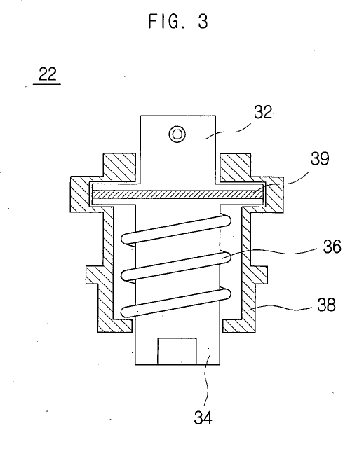

The friction hinge 22 may be joined with the output axis 26 of the worm gear 20 to engage and disengage the rotational force of the output axis 26. The friction hinge 22 may include an active axis, which joins with the output axis 26 of the worm gear 20, and a passive axis, which faces the active axis, where the friction between the active axis and passive axis can be controllable. The controlling of the friction between the active axis and passive can be to determine whether to engage or disengage the transfer of the rotational force of the output axis 26. The rotational force engaged by this friction hinge 22 can be transferred to the rotational axis 30, whereby the rotation of the rotational axis 30 can be controlled. The friction hinge will be described in greater detail later with respect to FIG. 3.

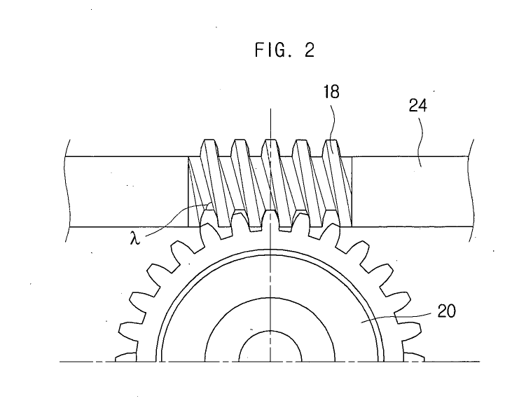

FIG. 2 is a schematic drawing illustrating a worm and a worm gear meshed together. In FIG. 2, there are illustrated a worm 18, a worm gear 20, and a main axis 24. The worm 18 may have a single thread, and a lead angle of λ. If the worm 18 has a single thread, a high deceleration rate can be obtained with just a small size. In this embodiment, the worm 18 may be formed on the perimeter of the main axis 24 of the gear module, so that the gear module may primarily decelerate the rotational speed and rotational force of the motor, and the worm 18 and worm gear 20 may provide secondary deceleration.

In cases where the lead angle (λ) is 6° or less, the worm 18 and worm gear 20 generally rotate in one direction only. Thus, the main axis 24 of the gear module and the output axis of the worm gear 20 can be arranged with the lead angle (λ) appropriately controlled, to allow rotation in both the clockwise and counter-clockwise directions. Examples of some of the considerations in arranging the main axis 24 and the output axis to allow clockwise and counter-clockwise rotation include: the ratio of the coefficient of friction between the worm 18 and worm gear 20 to tan λ, the degree of surface processing in the worm 18 and worm gear 20, the degree of lubrication, and vibration, etc. The main axis 24 and the output axis can thus be designed to be rotatable in either direction with a consideration of the collective effects of these parameters.

As a very high load is generally applied on the worm 18, the worm 18 can be formed using forged carbon steel or nickel chromium steel, etc. The forged carbon steel can be used by annealing SF490A, SF540A, or SF590A, etc., while nickel chromium steel can be used by quenching SNC631, SNC836, etc. The worm gear 20 can be formed using bronze casting or phosphor bronze casting, which may produce a structure that is not as hard as the worm 18.

FIG. 3 is a cross-sectional view of a friction hinge according to an embodiment of the invention. In FIG. 3 are illustrated a friction hinge 22, an active axis 32, a passive axis 34, an elastic member 36, a housing 38, and a washer 39.

The friction hinge 22 may be joined to the output axis of the worm gear to engage and disengage the rotational force of the output axis. The friction hinge 22 may include an active axis 32, which receives the driving force transferred from the output axis of the worm gear, and a passive axis 34 facing the active axis 32. For plane contact between the active axis 32 and passive axis 34, a flange may be formed at the opposing surface of each of the active axis 32 and passive axis 34. The friction may be controllable between the active axis 32 and passive axis 34. This controllable friction between the active axis 32 and passive axis 34 can be used to engage and disengage the rotational force of the output axis of the worm gear. To thus control and maintain the friction, an elastic member 36 can be interposed to control the degree of contact between the active axis 32 and the passive axis 34. In this embodiment, a coil spring may be inserted onto the passive axis 34 which may provide an elastic force, with the supporting points at the flange of the passive axis 34 and the housing 38, to keep the active axis 32 and passive axis 34 in close contact.

In order to transfer the rotational force of the output axis of the worm gear via the active axis 32 of the friction hinge 22 to the passive axis 34, the torque provided by to the friction between the active axis 32 and passive axis 34 may have to be greater than the torque provided by the output axis. If the torque provided by to the friction between the active axis 32 and passive axis 34 is smaller than the torque provided by the output axis of the worm gear, the rotational force of the output axis may not be completely transferred to the passive axis 34 of the friction hinge 22. Using this principle, the friction between the active axis 32 and passive axis 34 may be controlled to engage and disengage the rotational force of the output axis.

Protrusions can be formed on the opposing surfaces of the active axis 32 and passive axis 34 to provide a certain level of friction. In addition, to control the friction between the active axis 32 and the passive axis 34, a washer 39 may be interposed between the opposing surfaces of the active axis 32 and passive axis 34, where multiple washers 39 may be used as necessary to control the level of friction.

The maximum halting frictional torque between the active axis 32 and passive axis 34 can be made higher than the operation requirement torque of the output axis of the worm gear, while the maximum halting frictional torque between the active axis 32 and passive axis 34 can be made lower than the operation requirement torque of the output axis of the worm gear. Here, the maximum halting frictional torque refers to the torque provided by the maximum halting friction between the active axis 32 and passive axis 34, and the operation requirement torque of the output axis of the worm gear refers to the torque required to rotate the output axis of the worm gear. Also, the holding torque of the output axis of the worm gear refers to the maximum torque created in opposition to an external torque applied on the output axis of the worm gear while the motor is not operated. As the rotation of the output axis of the worm gear is primarily decelerated by the gear module joined to the motor and secondarily decelerated by the worm and worm gear joined to the gear module for a secondary deceleration, the holding torque of the output axis of the worm gear may be the sum of the holding torque of the meshing arrangement between the worm and worm gear, the holding torque of the combination of multiple gears within the gear module, the cogging torque of the motor itself, and the holding torque provided by the friction between other components.

As such, the friction may be controlled such that the maximum halting frictional torque between the active axis 32 and passive axis 34 to be higher than the operation requirement torque of the output axis of the worm gear and lower than the holding torque of the output axis of the worm gear. Then, the driving of the motor can provide automatic rotation, and should there be a forced rotation of the rotational axis joined to the friction hinge 22 while the motor is not under operation, slipping may occur between the active axis 32 and passive axis 34 of the friction hinge 22, so that the worm and worm gear, the gear module, and the motor may not be damaged due to an excessive load.

In using a friction hinge 22 to implement a power transmission apparatus that allows automatic rotation by the driving of the motor and manual rotation by a user, if the worm and worm gear are not used, the reverse rotational force by manual rotation of the rotational axis may have to be countered only by the cogging torque of the motor and the holding torque of the gear module to prevent the gear module and motor from being damaged by an excessive load. In cases where the holding torque of the gear module is constant, the damaging due to excessive load may have to be avoided by controlling the cogging torque of the motor. However, using a high cogging torque for the motor can cause noises or vibrations in the motor, whereas using a low cogging torque can generate counter electromotive voltage, which can create noise when a system control unit is joined and cause noises in the gear module joined to the motor. Therefore, in order to reduce noise and suppress the occurrence of counter electromotive voltage when handled manually, the worm and the worm gear can be interposed, to increase the deceleration efficiency of the motor while making it possible to readily rotate a mass such as an LCD and PDP, etc., using a motor having a relatively low cogging torque.

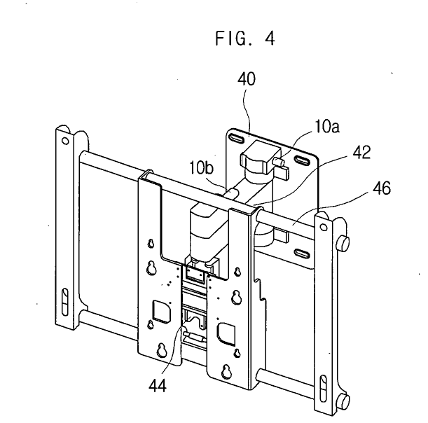

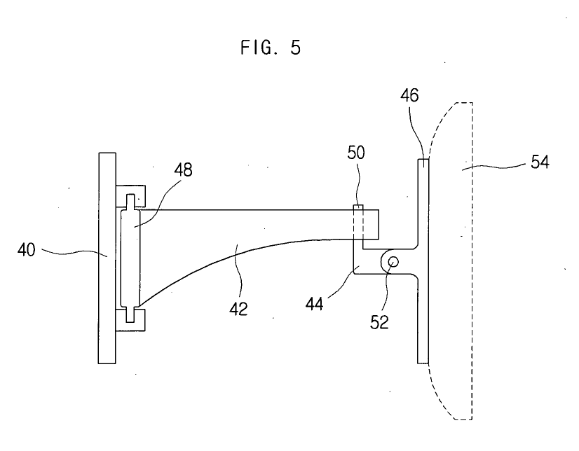

FIG. 4 is a perspective view of a rotation apparatus according to an embodiment of the invention, and FIG. 5 is a schematic drawing illustrating the composition of a rotation apparatus according to an embodiment of the invention. In FIGS. 4 and 5, there are illustrated a fixed body 40, a link member 42, a connector 44, a movable body 46, a first hinge axis 48, a second hinge axis 50, a third hinge axis 52, a first power transmission apparatus 10a, and a second power transmission apparatus 10b.

The rotation apparatus based on this embodiment may include a fixed body 40, a link member 42 having one end hinge-joined to the fixed body about a first hinge axis 48, a connector 44 hinge-joined to the other end of the link member 42 about a second hinge axis 50, a movable body 46 hinge-joined with the connector 44 about a third hinge axis 52, and a power transmission apparatus 10 joined to the first to third hinge axes 48, 50, 52 to control the rotation of the first to third hinge axes 48, 50, 52. That is, one power transmission apparatus 10 is joined to each of the first to third hinge axes 48, 50, 52, so that there are three power transmission apparatuses.

The power transmission apparatus 10 may be structured as described above, and may be joined to each hinge axis to control the rotation of the hinge axes. The rotation apparatus of this embodiment may have the first hinge axis 48 and the second hinge axis 50 in a substantially parallel configuration, and may have the second hinge axis 50 and the third hinge axis 52 in a substantially perpendicular configuration, to not only allow translational movement of the movable body 46 with respect to the fixed body 40, but also allow rotation of the movable body 46 in the left, right, upward, and downward directions.

In the rotation apparatus of this particular embodiment, the fixed body 40 may be secured to a wall, and a display such as an LCD and PDP, etc., may be secured to the movable body 46. In this way, the movable body 46 can be moved in a translational manner or rotated in the left, right, upward, and downward directions, such that the front of the display faces a direction desired by the user.

The rotation apparatus of this embodiment allows both automatic and manual operation.

Looking at the method of rotation in the rotation apparatus according to this embodiment for automatic operation, the first power transmission apparatus 10a joined to the first hinge axis 48, which may be secured to one end of the link member 42, may rotate the first hinge axis 48 to rotate the link member 42 about the first hinge axis 48, thereby allowing translational motion for the movable body 46. The second power transmission apparatus 10b joined to the second hinge axis 50, which may be secured to the connector 44, may rotate the second hinge axis 50, thereby allowing the movable body 46 to rotate left and right about the second hinge axis 50. The third power transmission apparatus (not shown) joined to the third hinge axis 52, which may be secured to the movable body 46, may rotate the third hinge axis 52, thereby allowing the movable body 46 to rotate up and down about the third hinge axis 52.

Each power transmission apparatus 10a, 10b may include a power generating part that includes a drive axis, a worm joined to the drive axis, a worm gear that meshes with the worm and includes an output axis for transmitting power, and a friction hinge joined to the output axis that engages and disengages the rotational force of the output axis, as described above, to control the rotation of the rotational axis. In this case, the power generating part may include a motor, and a gear module that reduces the rotational speed of the motor by a particular rate.

Thus, when power is supplied to the motor to rotate the drive axis of the motor, the rotational force of the motor can be transferred to the gear module via a drive pinion formed at the end of the drive axis. The rotation speed of the drive axis can be reduced by a predetermined rate by the combination of multiple gears within the gear module, and the decelerated rotational force can be outputted through the main axis of the gear module and transferred to the worm gear via the worm joined with the main axis. The rotation speed of the main axis may again be decelerated by the actions of the worm and worm gear and outputted via the output axis of the worm gear. The output axis of the worm gear may join with the active axis of the friction hinge, with the rotational force of the output axis of the worm gear transferred to the active axis of the friction hinge and the rotational force of the active axis transferred to the passive axis of the friction hinge. Here, the friction between the active axis and passive axis can be controlled, to determine whether to engage or disengage the transfer of the rotational force of the output axis to the hinge axis.

In this embodiment, the maximum halting frictional torque between the active axis and the passive axis can be made higher than the operation requirement torque of the output axis of the worm gear, such that there is no slipping between the active axis and passive axis. Thus, the rotational force of the output axis of the worm gear can be transferred to the hinge axis, and the hinge axis can be rotated, whereby the position of the movable body can be adjusted.

Looking at the method of rotation in the rotation apparatus for manual operation, if the user forcefully rotates the movable body while the motor is not in operation, the rotation of the movable body can create an excessive load on the gear module or on the motor, causing damage to the gear module or motor. To prevent this, the friction can be controlled such that the maximum halting frictional torque between the active axis and the passive axis is made lower than the holding torque of the output axis of the worm gear.

In other words, to allow rotation by manual operation as well as by automatic operation as described above, the friction between the active axis and the passive axis can be controlled such that the maximum halting frictional torque between the active axis and the passive axis is higher than the operation requirement torque of the output axis of the worm gear and lower than the holding torque of the output axis of the worm gear.

If the user forcefully rotates the movable body and applies a force greater than the maximum halting frictional torque between the active axis and passive axis, slipping may occur between the active axis and the passive axis, so that the rotational force due to the forced rotation of the hinge axis may not be transferred to the output axis of the worm gear, and as the holding torque of the output axis of the worm gear is higher, the gear module, motor, etc., are prevented from being subject to an excessive load. In this way, the user can rotate the movable body in a desired direction.

The description for each component of the power transmission apparatus 10a, 10b may be substantially the same as that presented above, and thus will not be repeated.

According to certain embodiments of the invention as set forth above, sufficiently high deceleration and high torque can be obtained, even when a low-capacity motor having a low cogging torque is used. Also, the power transmission apparatus or rotation apparatus can be made safer and less noisy for not only automatic operation by the motor but also manual operation by a user, while the gear module, motor, etc., can be protected from excessive loads.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A power transmission apparatus comprising:
a power generating part comprising a drive axis;
a worm joined to the drive axis;
a worm gear meshing with the worm and comprising an output axis, the output axis configured to transmit power; and
a friction hinge joined to the output axis and configured to engage and disengage a rotational force of the output axis.

2. The power transmission apparatus of claim 1, wherein the power generating part comprises:
a motor; and
a gear module configured to reduce a rotational speed of the motor by a predetermined rate.

3. The power transmission apparatus of claim 1, wherein the friction hinge comprises:
an active axis joined with the output axis of the worm gear; and
a passive axis in plane contact with the active axis,
and wherein a friction between the active axis and the passive axis is controllable.

4. The power transmission apparatus of claim 3, wherein a maximum halting frictional torque between the active axis and the passive axis is higher than an operation requirement torque of the output axis of the worm gear.

5. The power transmission apparatus of claim 3, wherein a maximum halting frictional torque between the active axis and the passive axis is lower than a holding torque of the output axis of the worm gear.

6. A rotation apparatus comprising:
a fixed body;
a link member having one end hinge-joined to the fixed body about a first hinge axis;
a connector hinge-joined to the other end of the link member about a second hinge axis;
a movable body hinge-joined with the connector about a third hinge axis; and
a power transmission apparatus joined to the first, second, and third hinge axes respectively and configured to control a rotation of the first, second, and third hinge axes,
wherein the power transmission apparatus comprises:
a power generating part comprising a drive axis;
a worm joined to the drive axis;
a worm gear meshing with the worm and comprising an output axis, the output axis configured to transmit power; and
a friction hinge joined to the output axis and configured to engage and disengage a rotational force of the output axis.

7. The rotation apparatus of claim 6, wherein the power generating part comprises:
a motor; and
a gear module configured to reduce a rotational speed of the motor by a predetermined rate.

8. The rotation apparatus of claim 6, wherein the friction hinge comprises:
an active axis joined with the output axis of the worm gear; and
a passive axis in plane contact with the active axis,
and wherein a friction between the active axis and the passive axis is controllable.

9. The rotation apparatus of claim 8, wherein a maximum halting frictional torque between the active axis and the passive axis is higher than an operation requirement torque of the output axis of the worm gear.

10. The rotation apparatus of claim 8, wherein a maximum halting frictional torque between the active axis and the passive axis is lower than a holding torque of the output axis of the worm gear.
